(19) United States
(12) Patent Application Publication
(10) Pub. No.: US 2009/0204286 A1
(43) Pub. Date: Aug. 13, 2009

(54) METHOD AND DEVICE OF LOCATING THE LONGITUDINAL POSITION OF WHEELS OF A VEHICLE

(75) Inventor: Olivier Costes, Tournefeuille (FR)

Correspondence Address: YOUNG & THOMPSON, 209 Madison Street, Suite 500, ALEXANDRIA, VA, 22314, US

(73) Assignee: CONTINENTAL AUTOMOTIVE FRANCE, TOULOUSE CEDEX 1 (FR)

(21) Appl. No.: 12/438,560

(22) PCT Filed: Jul. 25, 2007
(86) PCT No.: PCT/EP2007/006585

§ 371 Date: Feb. 24, 2009

(30) Foreign Application Priority Data
Aug. 25, 2006 (FR) 0607515

(51) Int. Cl. B60C 23/04

(52) U.S. Cl. 701/29

(57) ABSTRACT

A method for locating the longitudinal position, either on the front axle system, or on the rear axle system of a vehicle with an engine, of wheels (4) fitted with an electronic module (8). According to this method, a vibration sensor (15) is incorporated into each electronic module, and, in the first place, in a preliminary characterization phase, with the engine running, the signals delivered by the respective vibration sensors of a wheel mounted on the front axle system and of a wheel mounted on the rear axle system are analyzed in order to establish a criterion of differentiation of the signals. In addition, the procedure for locating the longitudinal position of the wheels (4) consists in analyzing the signals delivered by the various vibration sensors and in deducing from this analysis, by applying the differentiation criterion, information on the longitudinal position of each wheel.

The invention relates to a method and a device for locating the longitudinal position, either on the front axle system, or on the rear axle system of a vehicle with an engine, of wheels fitted with an electronic module suitable for transmitting, to a central unit mounted on the vehicle, signals representative of operating parameters of each wheel also comprising an identification code of the latter.

More and more motor vehicles have, for safety purposes, monitoring systems comprising sensors mounted on each of the wheels of the vehicle, dedicated to measuring parameters, such as pressure or temperature of the tyres fitted to these wheels, and designed to inform the driver of any abnormal variation of the measured parameter.

These monitoring systems are conventionally equipped with an electronic module mounted on each of the wheels of the vehicle, incorporating, in addition to the aforementioned sensors, a microprocessor and a radiofrequency transmitter (or RF transmitter), and a central unit for receiving the signals transmitted by the transmitters, comprising a computer incorporating a radiofrequency receiver (or RF receiver) connected to an antenna.

One of the problems that such monitoring systems need to solve lies in the obligation of associating, with each signal received by the central unit receiver, information concerning the location of the electronic module and therefore of the wheel that is at the origin of this signal, this obligation lasting the lifetime of the vehicle, that is to say having to be complied with even after wheel changes or more simply after switching the positions of these wheels.

Currently, a first location method consists in incorporating an accelerometer into each electronic module, and in using a location technique based on statistical methods consisting in comparing the accelerations of the various wheels to obtain information on the respective position of each of said wheels.

This location method is however not very efficient because it requires a considerable running time to produce a discrimination between the various wheels.

A second location method consists in using three low-frequency antennas each positioned close to one of the wheels of the vehicle, and in carrying out a location procedure consisting in successively exciting each of these three antennas by the transmission of a low-frequency magnetic field.

According to this procedure, the electronic module mounted on the wheel situated close to the excited antenna transmits, in response to and toward the central unit, a low-frequency signal comprising an identification code of said module, so that the successive excitation of the three antennas leads to the location of the three electronic modules mounted on the wheels close to these antennas, and by deduction, to the location of the fourth module.

The main advantage of such a method lies in the fact that the location procedure is very rapid and leads to a virtually instantaneous location after the vehicle has started.

On the other hand, this solution is extremely costly because it requires fitting the vehicle with three antennas with all the attendant constraints: connection cables, control amplifiers etc. such that it is costly.

For its part, the present invention is aimed at a third method dedicated to locating the longitudinal position (front axle system or rear axle system) of the wheels of a vehicle, and its main objective is to supply a location method that is extremely effective in terms of responsiveness and reliability, the application of which generates an overall cost that is markedly less than that generated, for one and the same end result, by the application of the current two methods discussed above.

Accordingly, the subject of the invention is a method for locating the longitudinal position, either on the front axle system, or on the rear axle system of a vehicle with an engine, of wheels fitted with an electronic module suitable for transmitting, to a central unit mounted on the vehicle, signals representative of operating parameters of each wheel also comprising a code for identifying the latter. According to the invention, this location method consists in incorporating a vibration sensor in each electronic module, and:
in a preliminary characterization phase, in analyzing, with the engine running, the signals delivered by the respective vibration sensors of a wheel mounted on the front axle system and of a wheel mounted on the rear axle system, so as to establish a criterion of differentiation of said signals,
and to set up a procedure for locating the longitudinal position of the wheels consisting in analyzing the signals delivered by the various vibration sensors, and to deduce from this analysis, by applying the differentiation criterion, information on the longitudinal position of each wheel.

It should be noted that, according to the invention, a “vibration sensor” is intended in a general manner to mean any sensor, such as advantageously a sensor of the piezoelectric type designed to supply a signal representative, in terms notably of amplitude and frequency, of the vibrations or mechanical impacts to which said sensor is subjected.

The invention has therefore consisted:
in using a totally innovative location technique based on the measurement, at the electronic modules, of the vibrations generated by the rotation of the engine of a vehicle,
in demonstrating that the signals delivered by two vibration sensors positioned on one and the same axle system, front or rear, have similar characteristics,
and in demonstrating that the signals delivered by two vibration sensors positioned on different axle systems have specific characteristics capable of making it possible to determine the longitudinal position of said vibration sensors.

Such a technique is, in the first place, very efficient in terms of responsiveness because it leads to a location of the longitudinal position of the wheels virtually immediately after the engine is started.

In addition, the vibration sensors necessary for applying the invention consist in sensors of simple and well-tried technology and lead, for one and the same end result, to an overall installation cost (supply, implantation and software adaptation) that is less than an installation comprising accelerometers.

Another advantage of the vibration sensors used according to the invention lies in their robustness that is particularly suited to the severe environmental conditions of the electronic modules.

According to an advantageous embodiment of the invention, the differentiation criterion is established from analyzing and comparing the amplitudes of the signals delivered by two vibration sensors fitted respectively to a wheel mounted on the front axle system and a wheel mounted on the rear axle system.

According to this principle, the location of the longitudinal position of the wheels results from a simple comparison of the amplitudes of the signals delivered by the vibration sensors.

The invention extends to a device for locating the longitudinal position of wheels of a vehicle with an engine, comprising:
a vibration sensor incorporated into each electronic module,
and means for analyzing and comparing the signals delivered by the various vibration sensors, capable of making it possible to differentiate the signals delivered by two vibration sensors fitted respectively to a wheel mounted on the front axle system and a wheel mounted on the rear axle system.

Other features, objects and advantages of the invention will emerge from the following detailed description given with reference to the appended drawings which represent thereof, as a nonlimiting example, a preferred embodiment. In these drawings:

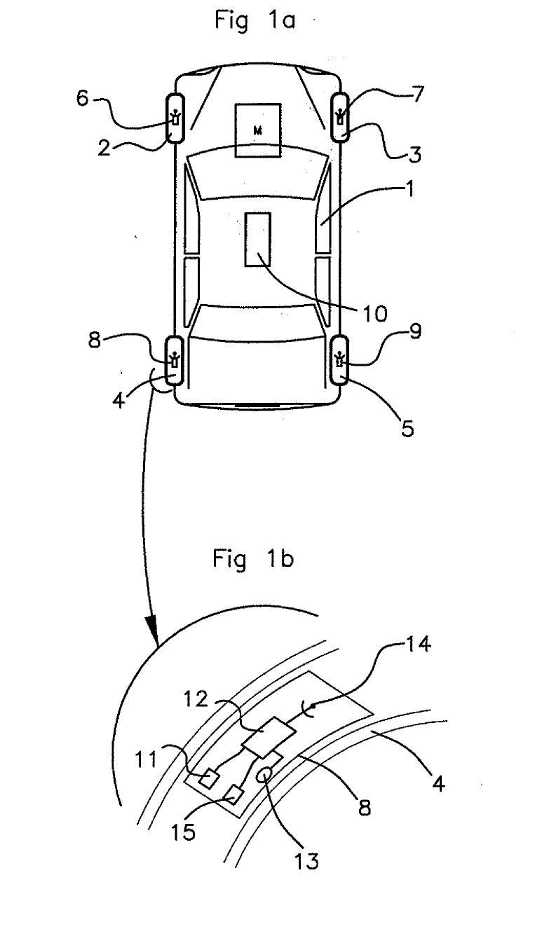

FIG. 1a is a top schematic view of a vehicle furnished with a monitoring system associated with a device according to the invention for locating the longitudinal position of the wheels of said vehicle,

FIG. 1b is a detailed schematic view in perspective representing a portion of a wheel of this vehicle and the electronic module fitted to the latter,

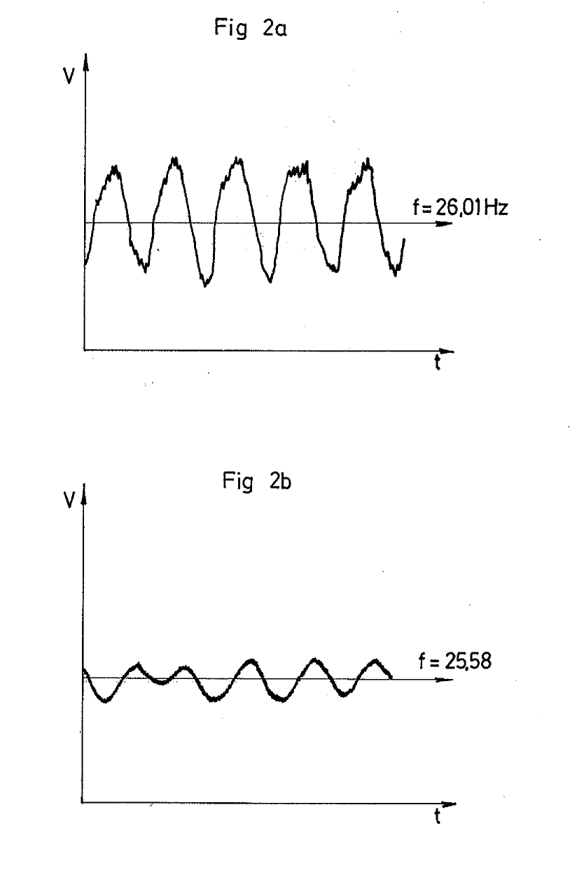

FIGS. 2a and 2b represent the signals delivered by vibration sensors according to the invention respectively mounted on a front wheel (FIG. 2a) and a rear wheel (FIG. 2b).

The location device according to the invention represented as an example in FIGS. 1a and 1b is designed to locate the longitudinal position (front wheel or rear wheel) of the wheels of a vehicle.

This location device is more specifically designed to be installed on vehicles furnished with a system for monitoring the pressur e of the tyres such as that represented in FIG. 1a fitted to a vehicle 1 with a motor M furnished with four wheels conventionally shod with a tyre: two front wheels 2, 3 and two rear wheels 4, 5.

Such monitoring systems conventionally comprise, in the first place, associated with each wheel 2-5, an electronic module 6-9, for example secured to the rim of said wheel so as to be positioned on the inside of the cover of the tyre.

Each of these electronic modules 6-9 incorporates, for example, sensors 11 dedicated to measuring parameters, such as pressure and/or temperature of the tyre, connected to a computer unit 12 with a microprocessor supplied electrically by means of a button cell 13, and connected to an RF transmitter connected to a high-frequency antenna 14.

The monitoring system also comprises a central computer or central processor unit 10, situated in the vehicle 1, comprising a microprocessor and incorporating an RF receiver capable of receiving the signals transmitted by each of the four electronic modules 6-9.

Usually, such a monitoring system and notably its central processor unit 10 are designed so as to inform the driver of any abnormal variation of the parameters measured by the sensors 11 associated with the wheels 2-5.

Associated with this monitoring system and forming an integral part of the latter, the location device according to the invention has the function of making it possible to associate with each signal received by the central processor unit 10 information concerning the longitudinal position of the wheel 2-5 fitted with the electronic module 6-9 that is at the origin of this signal.

Accordingly, this location device comprises a vibration sensor 15, for example of the piezoelectric type, incorporated into each electronic module 6-9 and suitable for supplying a signal that is representative, in terms notably of amplitude and frequency, of the vibrations or mechanical impacts to which said sensor is subjected during the operation of the engine M.

Such vibration sensors 15 positioned according to the invention have the following particular features that are determinant according to the principle of the invention:
two vibration sensors 15 positioned on one and the same axle system, front or rear, deliver signals having similar characteristics,
and two vibration sensors 15 positioned on different axle systems deliver signals having specific characteristics suitable for making it possible to determine the longitudinal position of said vibration sensors.

These particular features make it possible to apply a location method consisting, according to the invention, for each given model of vehicle 1:
in a preliminary characterization phase, in analyzing, with the engine M running, the signals delivered by the respective vibration sensors 15 of a front wheel 2, 3 and of a rear wheel 4, 5 in order to establish a criterion of differentiation of said signals,
and to set up a procedure for locating the longitudinal position of the wheels 2-5 consisting in analyzing the signals delivered by the various vibration sensors 15, and to deduce from this analysis, by applying the differentiation criterion, information on the longitudinal position of each wheel.

Furthermore, as a general rule, and as illustrated in FIGS. 2a and 2b, the two sensors 15 fitted to the wheels closest to the engine M (front wheels 2, 3 according to the example described) are subjected to vibrations (and therefore deliver signals) of an amplitude greater than that of the vibrations to which the other two sensors 15 fitted to the two rear wheels 4, 5 are subjected.

The amplitude of the signals delivered by the sensors 15 being proportional to those of the vibrations to which the latter are subjected, the criterion of differentiation therefore most frequently simply causes the values of the amplitudes of the signals delivered by the sensors 15 to be involved as basic parameters allowing the decision to be taken.

The location method according to the invention described above therefore makes it possible, subject to installing a simple, low-cost vibration sensor in each electronic module on board a vehicle wheel, to very quickly and reliably locate the longitudinal position of said wheel.

1. A method for locating the longitudinal position, either on the front axle system, or on the rear axle system of a vehicle (1) with an engine (M), of wheels (2-5) fitted with an electronic module (6-9) suitable for transmitting, to a central unit (10) mounted on the vehicle (1), signals representative of operating parameters of each wheel also comprising a code for identifying the latter, said location method being characterized in that it consists in incorporating a vibration sensor (15) into each electronic module (6-9), and:
in a preliminary characterization phase, in analyzing, with the engine (M) running, the signals delivered by the respective vibration sensors (15) of a wheel (2, 3) mounted on the front axle system and of a wheel (4, 5) mounted on the rear axle system, so as to establish a criterion of differentiation of said signals,
and to set up a procedure for locating the longitudinal position of the wheels (2-5) consisting in analyzing the signals delivered by the various vibration sensors (15), and to deduce from this analysis, by applying the differentiation criterion, information on the longitudinal position of each wheel.

2. The location method as claimed in claim 1, characterized in that the criterion of differentiation is established from analyzing and comparing the amplitudes of the signals delivered by two vibration sensors (15) fitted respectively to a wheel (2, 3) mounted on the front axle system and a wheel (4, 5) mounted on the rear axle system.

3. A location device using the location method as claimed in claim 1, said location device being characterized in that it comprises:
a vibration sensor (15) incorporated into each electronic module (6-9),
and means (10) for analyzing and comparing the signals delivered by the various vibration sensors (15), capable of making it possible to differentiate the signals delivered by two vibration sensors fitted respectively to a wheel (2, 3) mounted on the front axle system and a wheel (4, 5) mounted on the rear axle system.

4. The location device as claimed in claim 3, characterized in that each vibration sensor (15) consists of a sensor of the piezoelectric type.

5. A location device using the location method as claimed in claim 2, said location device being characterized in that it comprises:
a vibration sensor (15) incorporated into each electronic module (6-9),
and means (10) for analyzing and comparing the signals delivered by the various vibration sensors (15), capable of making it possible to differentiate the signals delivered by two vibration sensors fitted respectively to a wheel (2, 3) mounted on the front axle system and a wheel (4, 5) mounted on the rear axle system.

6. The location device as claimed in claim 5, characterized in that each vibration sensor (15) consists of a sensor of the piezoelectric type.
